(19) United States
(12) Patent Application Publication
(10) Pub. No.: US 2016/0281353 A1
(43) Pub. Date: Sep. 29, 2016

(54) Acoustic Assembly

(71) Applicant: Fabric Images, Inc., Elgin, IL (US)

(72) Inventors: Jason Todd Gillette, Elgin, IL (US); Alvaro Manuel Luna, Elgin, IL (US)

(21) Appl. No.: 14/669,855

(22) Filed: Mar. 26, 2015

(51) Int. Cl. E04B 1/99; G10K 11/16

(52) U.S. Cl. CPC E04B 1/99; G10K 11/16

(57) ABSTRACT

An acoustic assembly includes a plurality of first slats and at least one second slat couplable with each one of the first slats for intersecting with each first slat. Each slat is preferably made from a substrate of a rigid or a semi-rigid material and has oppositely disposed second end portions. An engagement portion is coupled with each first and second end portion for resting atop at least one architectural element for supporting the acoustic assembly. The assembly may include a shear portion and a catch portion for providing a locking mechanism for further securing the first slats with the second slats. When the acoustic canopy is supported from the first and second end portions, the slats may sag to compress open-ended slots of the second slats for pinching the corresponding ones of the first slats received within the open-ended slots.

### FIELD OF THE INVENTION

The present invention relates to assemblies for improving the acoustics of a space. More specifically, the present invention relates to acoustic assemblies for at least one of absorbing diffusing and directing sound in and around a space.

### BACKGROUND

In recent years, designers, architects and space planners have been following a trend of creating open plan or open concept work environments with the intent of providing cohesive and collaborative environments for greater ease of interaction between everyone within the work space. Workplaces are being designed with open ceiling structures, partitions and walls which are lower in height and fewer in number and more collaborative surfaces, flex zones and touchdown spaces. At the same time, rising costs have forced more people to work in less area.

Arising from this trend of open work environments are issues relating to noise, privacy and unwanted sound transmission through the work space. Ringing telephones, conversation and shuffling papers are examples of noise that propagates through an open space and which can pose a distraction to workers and a barrier to effective communication between two or more people. Moreover, the open concept work environment may make it difficult to find an appropriate space for a private meeting or to perform focused work that requires concentration.

Poor acoustics in an open work environment has resulted in an increased demand for control of noise and sound transmission in the work space.

### SUMMARY

The present invention provides an acoustic assembly. The assembly includes a plurality of first slats of acoustic material and at least one second slat of acoustic material couplable with each one of the plurality of first slats for intersecting with each of the first slats. Each first slat has oppositely disposed first end portions and each second slat has oppositely disposed second end portions. An engagement portion is coupled with each first end portion and each second end portion for resting atop at least one architectural element for supporting the acoustic assembly.

In one aspect, the assembly may include a plurality of second slats. Each of the first slats and second slats may be fabricated from an acoustic substrate of one of a rigid and a semi-rigid material. The first slats may be parallel relative one another and the second slats may be parallel relative one another. The acoustic assembly preferably at least one of absorbs, diffuses and directs sound.

As used herein, the term “substrate” may refer to an acoustic material that is used singularly to fabricate the first slats and second slats or to an acoustic material that is used in combination with other acoustic or non-acoustic materials to fabricate the first slats and the second slats. For example, in one embodiment the first slats and second slats may be fabricated only from an acoustic substrate such as acoustic boards of pressed felt. In another embodiment, the first slats and second slats may be fabricated from an acoustic substrate such as composite boards or boards with an acoustic substrate insert.

The acoustic assembly may be an acoustic canopy assembly wherein the at least one second slat is couplable with each one of the plurality of first slats for intersecting with each of the first slats from beneath each of the first slats.

Each engagement portion may be a supporting tab for extending onto the at least one architectural element for supporting the acoustic assembly.

Each of the first slats and each of the second slats may each have a distinct profile defined by at least one of a respective arbitrary curve, an evolving radius, a linear form and a curvilinear form. The first slats and the second slats may collectively provide the acoustic assembly with at least one undulation when the at least one second slat is intersected with the plurality of first slats. The undulation may be at least one of a depression, a planar zone and a bulge.

In another embodiment, each of the first slats has a first profile defined by at least one of a first respective arbitrary curve, a first evolving radius, a first linear form and a first curvilinear form and each of the second slats has a second profile defined by at least one of a second respective arbitrary curve, a second evolving radius, a second linear form and a second curvilinear form. The first slats may collectively provide the acoustic assembly with a first undulation when the at least one second slat is intersected with the plurality of first slats, the first undulation visible from a first perspective. The second slats may collectively provide the acoustic assembly with a second undulation when the at least one second slat is intersected with the plurality of first slats, the second undulation coincident with the first undulation and visible from a second perspective different from the first perspective.

In another aspect, the acoustic assembly includes a plurality of first slats of an acoustic substrate of one of a rigid material and a semi-rigid material and at least one second slat of the acoustic substrate couplable with each one of the plurality of first slats for intersecting with each of the first slats. At least one first aperture passes through each first slat and a plurality of second apertures passes through the at least one second slat. The second apertures are longitudinally spaced apart along the at least one second slat. The plurality of second apertures corresponds in number with the plurality of first slats. A shear portion is adjacent one of the at least one first aperture and each second aperture of the plurality of second apertures. The shear portion has a slit passing therethrough to the one of the at least one first aperture and each second aperture of the plurality of second apertures for selectively opening and closing the one of the at least one first aperture and each second aperture of the plurality of second apertures. A catch portion is adjacent the other one of the at least one first aperture and each second aperture of the plurality of second apertures.

When the one of the at least one first aperture and each second aperture of the plurality of second apertures is selectively open, the catch portion is receivable within the one of the at least one first aperture and each second aperture of the plurality of second apertures. When the one of the at least one first aperture and each second aperture of the plurality of second apertures is selectively closed, the catch portion is removably securable within the one of the at least one first aperture and each second aperture of the plurality of second apertures and the shear portion is removably securable within the other one of the at least one first aperture and each second aperture of the plurality of second apertures.

In this aspect, the assembly preferably includes a plurality of second slats and the shear portion is adjacent each first slat and the catch portion is adjacent each second slat. The first slats may be parallel relative one another and the second slats may be parallel relative one another.

In this aspect, the first slats remain coupled or secured with a corresponding intersecting second slat during the construction of the acoustic assembly.

In another aspect, the acoustic canopy assembly includes a plurality of first slats of acoustic material and at least one second slat of an acoustic substrate of a rigid material and a semi-rigid material. Each first slat has opposed first end portions and a first open-ended slot extending partially across each first slat. Each second slat has opposed second end portions and a plurality of second open-ended slots extending partially across the at least one second slat. The plurality of second open-ended slots is cooperable with corresponding ones of the first open-ended slots for receiving a corresponding one of the first slats within each second open-ended slot for intersecting each of the first slats from beneath the first slats. When the acoustic canopy is supported from the first and second end portions, the semi-rigid acoustic material of the at least one second slat sags to compress the second open-ended slots for pinching the corresponding ones of the first slats within the second slots.

Each second slat may include a top portion extending longitudinally therealong and a bottom portion extending longitudinally therealong. When the at least one second slat sags, the top portion is under compression and the bottom portion is under tension. The second open-ended slot is narrowed for pinching the corresponding one of the first slats within the second-open ended slot. This pinching effect strengthens the canopy assembly to a degree where no additional fastening hardware is necessary. The first slats may be parallel relative one another and the second slats may be parallel relative one another.

The acoustic assembly provides a transformation from two-dimensional components to a three-dimensional acoustic product. The acoustic assembly offers sustainable, unique styling that is adaptable for any space. The acoustic substrate from which the assembly is constructed is preferably an inherently flame-retardant, recyclable, self-supporting, sound absorption material that significantly reduces reverberation time (RT60) and improves speech clarity. The acoustic assembly may improve speech privacy between rooms or work spaces to bring down the overall noise level in an environment. The acoustic assembly can be custom fit to accommodate any specialty ceiling application, ambient structural, plumbing or electrical architecture or desired acoustic performance. The acoustic assembly does not interfere with sprinkler system penetration or light penetration into a work space.

### BRIEF DESCRIPTION OF THE DRAWINGS

For a better understanding of the nature and objects of the present invention reference may be had by way of example to the accompanying diagrammatic drawings in which:

FIG. 1 is a perspective view of one exemplary embodiment of the acoustic assembly positioned over a room;

FIG. 2 is an enlarged view of the acoustic assembly shown in FIG. 1;

FIG. 3 is another perspective view of the acoustic assembly shown in FIG. 2;

FIG. 4 is a perspective view of the acoustic assembly as a free-standing structure;

FIG. 5 is a perspective view of an individual first slat;

FIG. 6 is a perspective view of an individual second slat;

FIG. 7a is a perspective view of a representation of one exemplary configuration of the profiles of the first slats and second slats;

FIG. 7b is a perspective view of the acoustic assembly shown in FIG. 7a;

FIG. 8a is a perspective view of a representation of another exemplary configuration of the profiles of the first slats and second slats;

FIG. 8b is a perspective view of a representation of another exemplary configuration of the profiles of the first slats and second slats;

FIG. 8c is a perspective view of one embodiment of the acoustic assembly;

FIG. 9 is a view of the open-ended slots and the locking mechanism of the first and second slats;

FIG. 10 is a view of the coupling between first and second slats;

FIG. 11 is a side view of the sagging effect on a second slat;

FIG. 12 is a side view of the pinching effect on one of the second open-ended slots shown in FIG. 11; and,

FIG. 13 is a perspective view of the first and second support slats.

### DETAILED DESCRIPTION

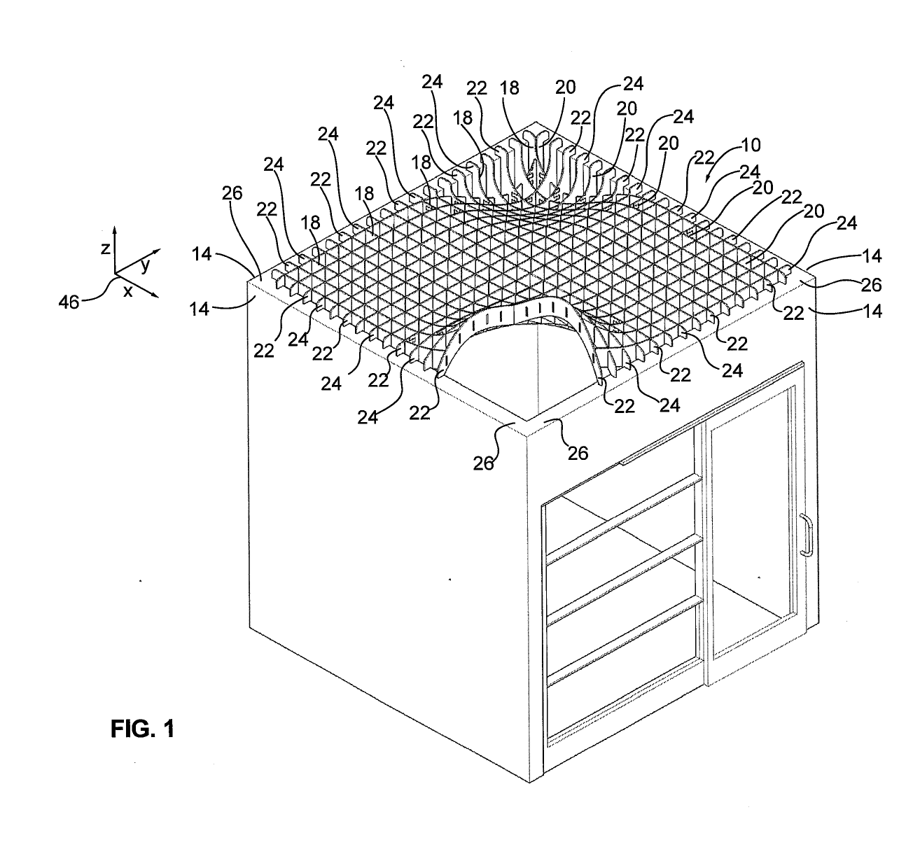

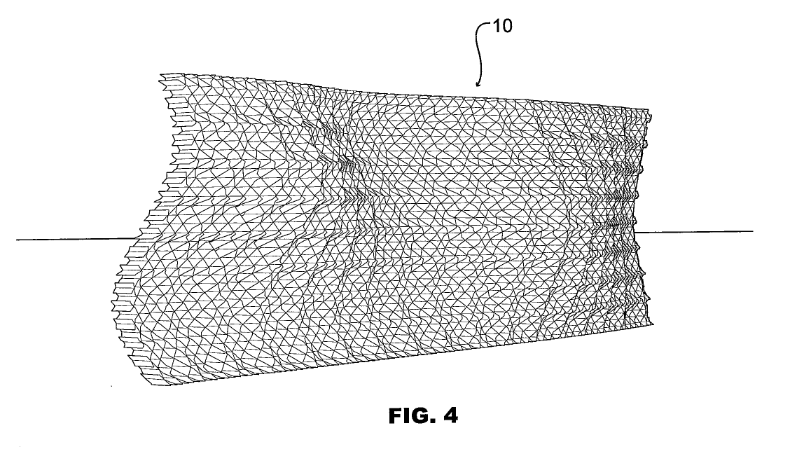

The acoustic assembly 10 is shown in FIG. 1 as an acoustic canopy assembly positioned over a room or space 12 defined by four walls 14. Although four walls 14 are shown in FIG. 1, it should be understood that the acoustic assembly 10 could be positioned over a room 12 having any number of walls 14. The room 12 may be any space, such as for example a residential, commercial or industrial space. The acoustic assembly 10 may also be a free-standing structure as shown in FIG. 4. For example, the acoustic assembly 10 may be positioned as an accent or centerpiece on the floor of room 12. Accordingly, the acoustic assembly 10 may have a three-dimensional configuration. The acoustic assembly 10 at least one of absorbs, diffuses or directs sound within or around the room 12. FIG. 1 includes coordinate key 46 labeling imaginary x, y and z axes for the acoustic assembly 10.

The acoustic assembly 10 of FIG. 1 is oriented generally horizontally over room 12 and may be applied over an entire room or part of a room. The acoustic assembly 10 may also be vertically oriented or at least partially vertically oriented to act, for example, as a divider or partial divider to provide two spaces within a room or to accommodate or circumvent existing architectural features. Such existing architectural features may be, for example, walls, support columns, ledges, lighting, ventilation, mechanical architecture, electrical architecture, sprinkler systems or plumbing architecture.

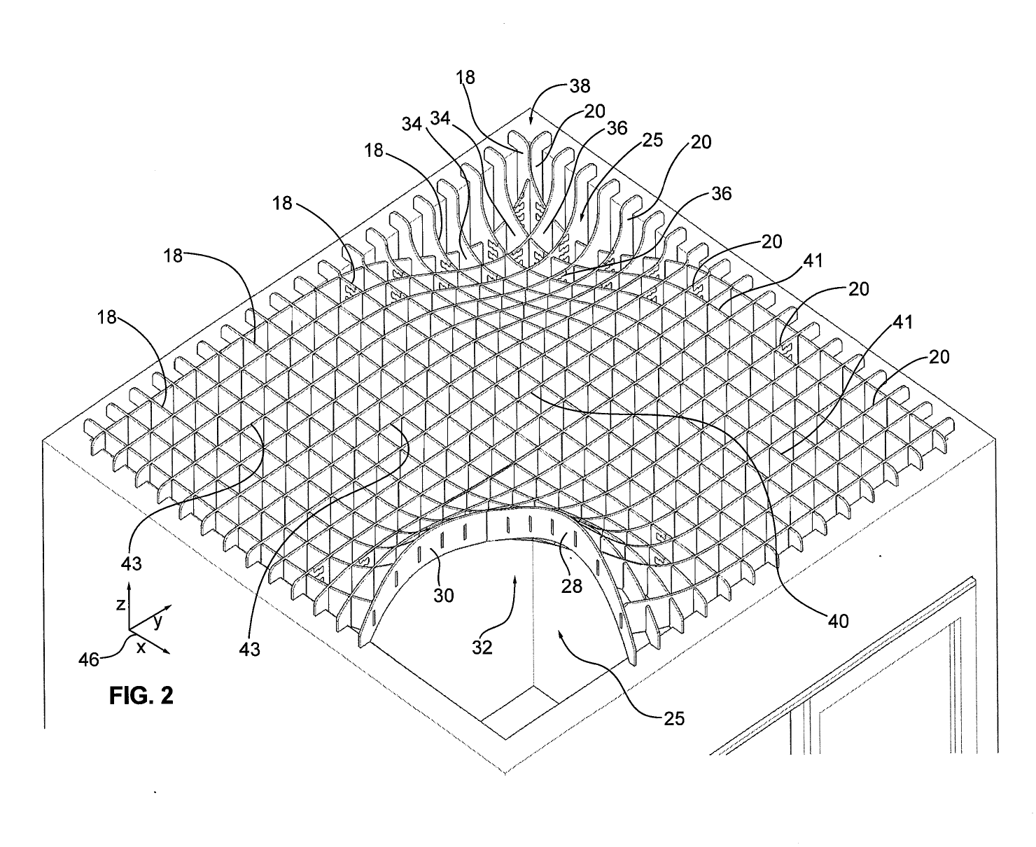

The acoustic assembly 10 includes a plurality of first slats 18 and a plurality of second slats 20. The plurality of first slats 18 and the plurality of second slats 20 preferably provide an array of slats for the acoustic assembly 10. The first slats 18 are preferably parallel relative one another and extend in the x-direction. The second slats 20 are preferably parallel relative one another and extend in the y-direction. It should be understood that the acoustic assembly 10 may include only a single second slat 20. However, acoustic assembly 10 preferably includes a plurality of second slats 20. The second slats 20 are couplable with first slats 18 for intersecting with each of the first slats 18. Although the second slats 20 are preferably disposed perpendicularly relative to the first slats 18 as shown in FIGS. 1 and 2, it should be understood that the second slats 20 may intersect with first slats 18 non-perpendicularly or angularly oriented relative to the first slats 18.

Each of the first slats 18 and second slats 20 have oppositely disposed end portions 22. Each oppositely disposed end portion 22 has an engagement portion 24 depending therefrom. Each engagement portion 24 engages the top edge portion 26 a respective one of walls 14 such that each end portion 22 rests atop the top edge portion 26 of one of walls 14. The acoustic assembly 10 is supported by the engagement portions 24 of first slats 18 and second slats 20. Preferably, the engagement portions 24 are supporting tabs which extend from the end portion 22 onto the respective one of walls 14. Although FIG. 1 shows that each engagement portion 24 rests atop the top edge portion 26 of a respective one of walls 14, it should be understood that the engagement portions 24 may be adapted to rest atop any architectural component for supporting the acoustic assembly 10. Such an architectural component may be, for example, a floor, a ledge or a support beam.

Preferably, one or both of first slats 18 and second slats 20 are fabricated from an acoustic substrate of at least one of a rigid material and a semi-rigid material such as felt boards. However, other semi-rigid acoustic materials may also be appropriate for use with the acoustic assembly 10. The acoustic substrate may absorb, diffuse or direct sound or any combination thereof.

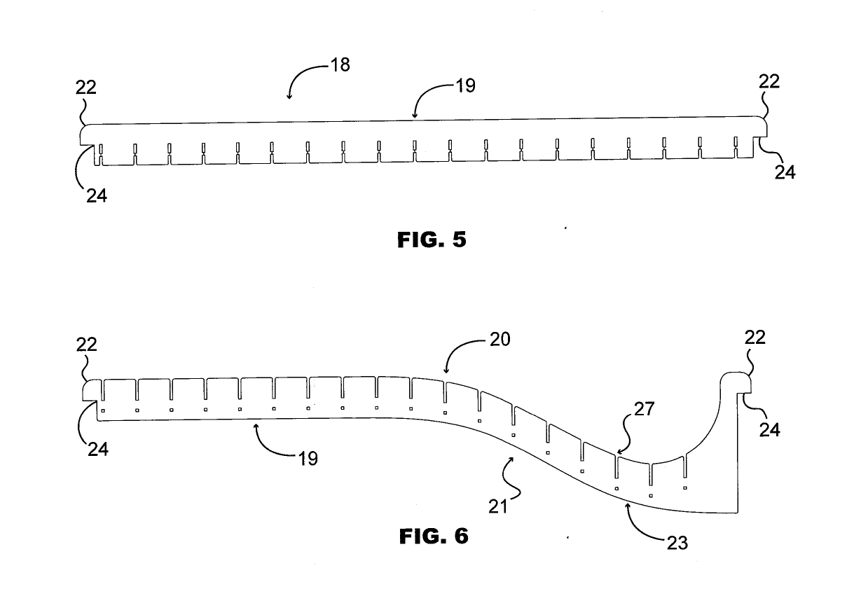

First slats 18 and second slats 20 may each have a distinct profile defined by at least one of an arbitrary curve, an evolving radius, a linear form and a curvilinear form. For example, FIG. 5 illustrates an individual first slat 18 having a profile with a linear form 19. It should be understood that although an exemplary first slat 18 is shown in FIG. 5, second slats 20 may also have a profile with a linear form 19. FIG. 6 illustrates an individual second slat 20 having a profile including a linear form 19, a curvilinear form 21, an arbitrary curve 23 and an evolving radius 27. It should be understood that although an exemplary second slat 20 is shown in FIG. 6, first slats 18 may also have a profile including a linear form 19, a curvilinear form 21, an arbitrary curve 23 and an evolving radius 27. Accordingly, the profiles of each first slat 18 and each second slat 20 are independent from one another. The distinct profiles of each individual first slat 18 and each individual second slat 20 may collectively provide any desired configuration to the acoustic assembly 10 in the assembled state. Preferably, the first slats 18 and the second slats 20 collectively provide at least one undulation 25 in the acoustic assembly 10. Each undulation 25 may include at least one of an upward bulge or convexity 32, a downward bulge or depression 38 or an interruption or planar zone 40.

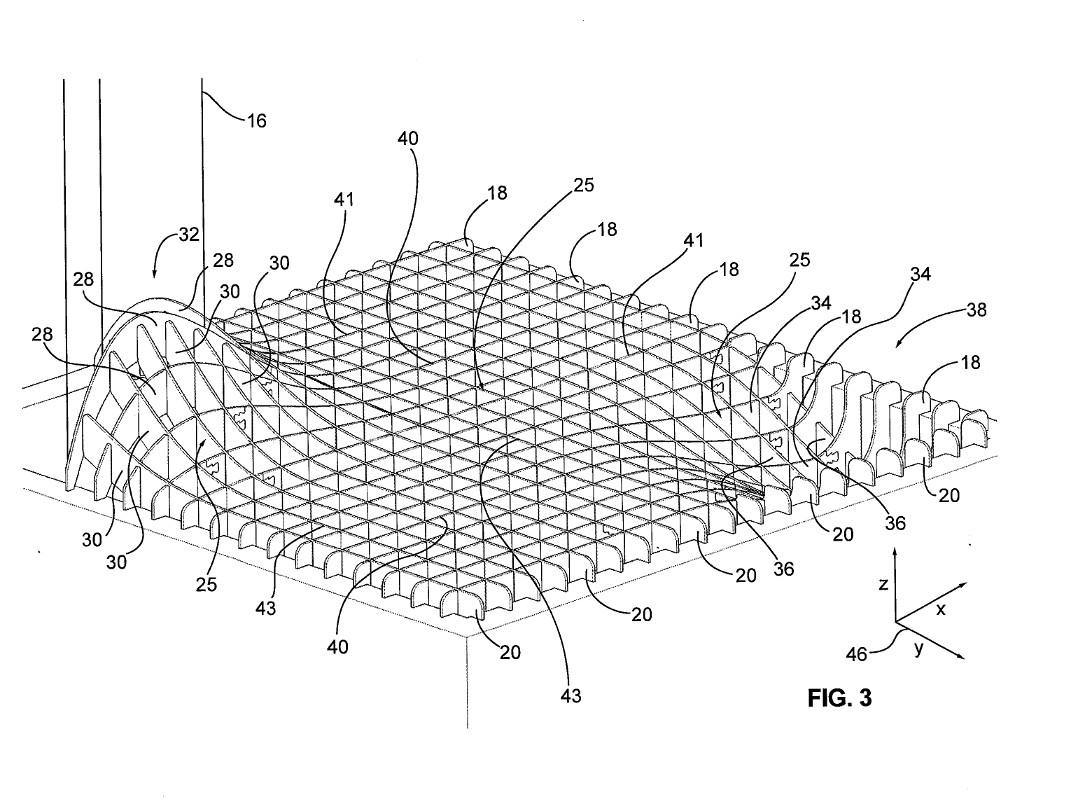

For example, as shown in FIGS. 2 and 3, portions 28 of the first slats 18 may have an upwardly curved profile and portions 30 of the second slats 20 may also have an upwardly curved profile. Collectively, the portions 28 of the first slats 18 and the portions 30 of the second slats 18, when coupled, provide an acoustic assembly 10 having a bulge or convexity 32 projecting upwardly from the acoustic assembly 10. As similarly shown in FIGS. 2 and 3, portions 34 of the first slats 18 may have a downwardly curved profile and portions 36 of the second slats 20 may also have a downwardly curved profile. Collectively, the portions 34 of the first slats 18 and the portions 36 of the second slats 20 provide an acoustic assembly 10 having depression 38 projecting downwardly from the acoustic assembly 10. The first slats 18 and the second slats 20 may also include interruptions or planar zones 40. Such planar zones 40 may be provided in embodiments wherein first slats 18 have portions 41 having a linear profile or a substantially linear profile and where second slats 20 have portions 43 having a linear profile or a substantially linear profile. The configuration of acoustic assembly 10 may be adapted to fit any space while circumventing ambient architecture, while providing a more visually appealing design for the acoustic assembly 10 or while optimizing the acoustics of the room 12. Such ambient architecture may be, for example, mechanical, electrical and plumbing architecture. For example, as shown in FIG. 3, the bulge 32 circumvents support column 16. Upwardly and downwardly in the context of FIGS. 2 and 3 may be upward and downward relative to an imaginary z-axis passing perpendicularly relative to an imaginary horizontal x-y plane passing through the acoustic assembly 10. FIGS. 2 and 3 include coordinate key 46 labeling imaginary x, y and z axes of the acoustic assembly 10.

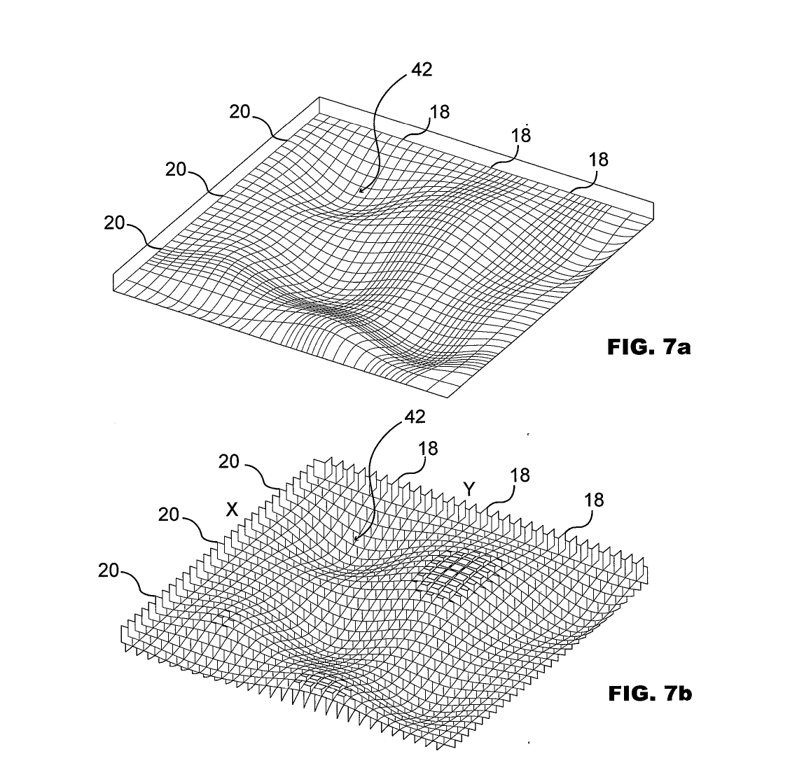

The configuration of the acoustic assembly 10 as shown in FIGS. 2 and 3 is provided by first slats 18 and second slats 20 generated by a single form. This concept is illustrated in FIG. 7a and FIG. 7b. In FIG. 7a, the profiles of each of the first slats 18 and the second slats 20 are coordinated or complementary to both provide bulges 32, depressions 38 and planar zones 40 in the same position on the acoustic assembly 10. Accordingly, a viewer viewing the acoustic assembly 10 along the first slats 18 or along the x-axis would identify bulges 32, depressions 38 and planar zones 40 in the same positions as they would in viewing the acoustic assembly 10 from along the second slats 20 or y-axis. The profiles of first slats 18 and second slats 20 are flush with one another, as shown, for example, at exemplary bulge 42.

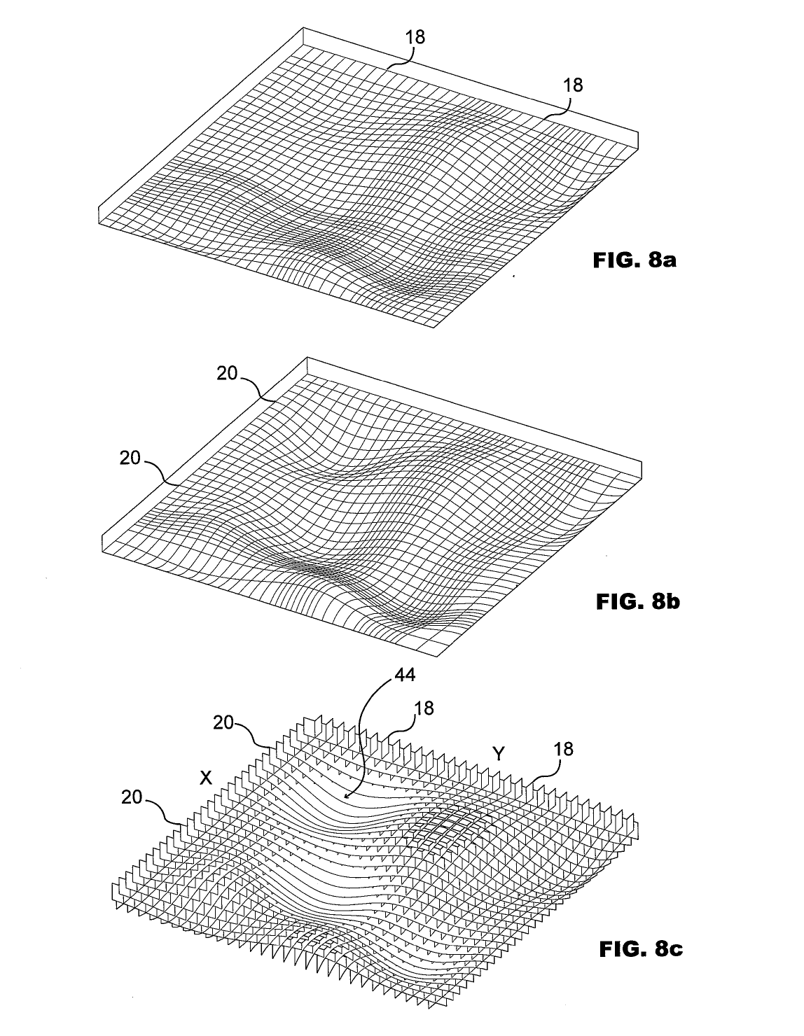

In another embodiment, the configuration of acoustic assembly 10 is generated from different forms. This concept is illustrated in FIGS. 8a, 8b and 8c. FIGS. 8a and 8b, examined individually, are similar to FIG. 7a in that the profiles of each of the first slats 18 and the second slats 20 are coordinated or complementary to both provide bulges 32, depressions 38 and planar zones 40 in the same position or coincident positions on the acoustic assembly 10. However, the configuration of the acoustic assembly 10 shown in FIG. 8c is provided by first slats 18 having the profiles shown in FIG. 8a and by second slats 20 having the profiles shown in FIG. 8b. Accordingly, a viewer viewing the acoustic assembly 10 along the first slats 18 of FIG. 8c or along the x-axis would identify bulges 32, depressions 38 and planar zones 40 in different positions as they would in viewing the acoustic assembly 10 along the second slats 20 of FIG. 8c or along the y-axis. The profiles of first slats 18 and second slats 20 are not necessarily flush with each other, as shown, for example, at the exemplary second slat bulge 44. In this manner, the acoustic assembly 10 may have a three-dimensional appearance.

Accordingly, in the embodiment shown in FIG. 8c, each of the first slats 18 has a first profile defined by at least one of a first respective arbitrary curve, a first evolving radius, a first linear form and a first curvilinear form. Each of the second slats 20 has a second profile defined by at least one of a second respective arbitrary curve, a second evolving radius, a second linear form and a second curvilinear form. The first slats 18 collectively provide the acoustic assembly 10 with a first undulation 25 when the at least one second slat 20 is intersected with the plurality of first slats 18. The first undulation 25 is visible from a first perspective such as, for example, a perspective along the y-axis or second slats 20. The second slats 20 collectively provide the acoustic assembly 10 with a second undulation 25 when the at least one second slat 20 is intersected with the plurality of first slats 18, the second undulation 25 is coincident with the first undulation 25 and visible from a second perspective different from the first perspective such as, for example, a perspective along the x-axis or first slats 18. In this manner, the acoustic assembly 10 may have a configuration which includes both a bulge 32 and a depression 38 in the same position on the acoustic assembly 10. Other combinations of a bulge 32, a planar zone 40 and a depression 38 at the same position in acoustic assembly 10 are also possible.

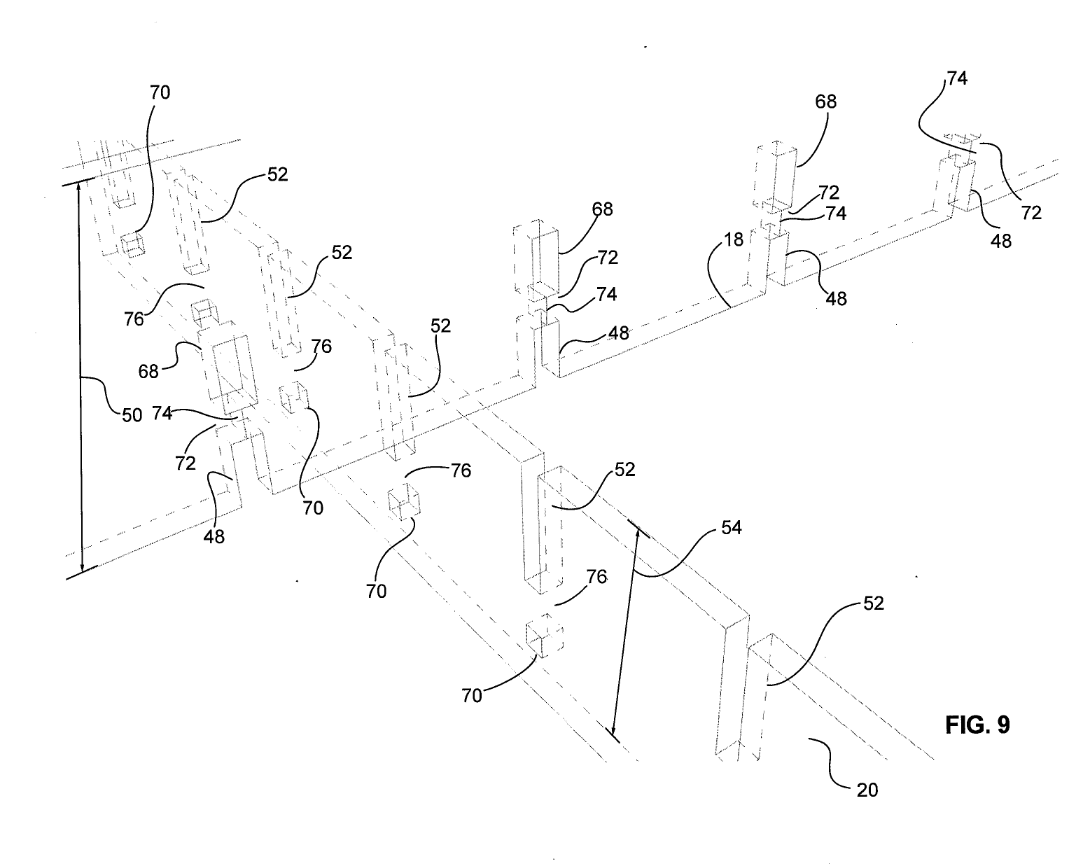

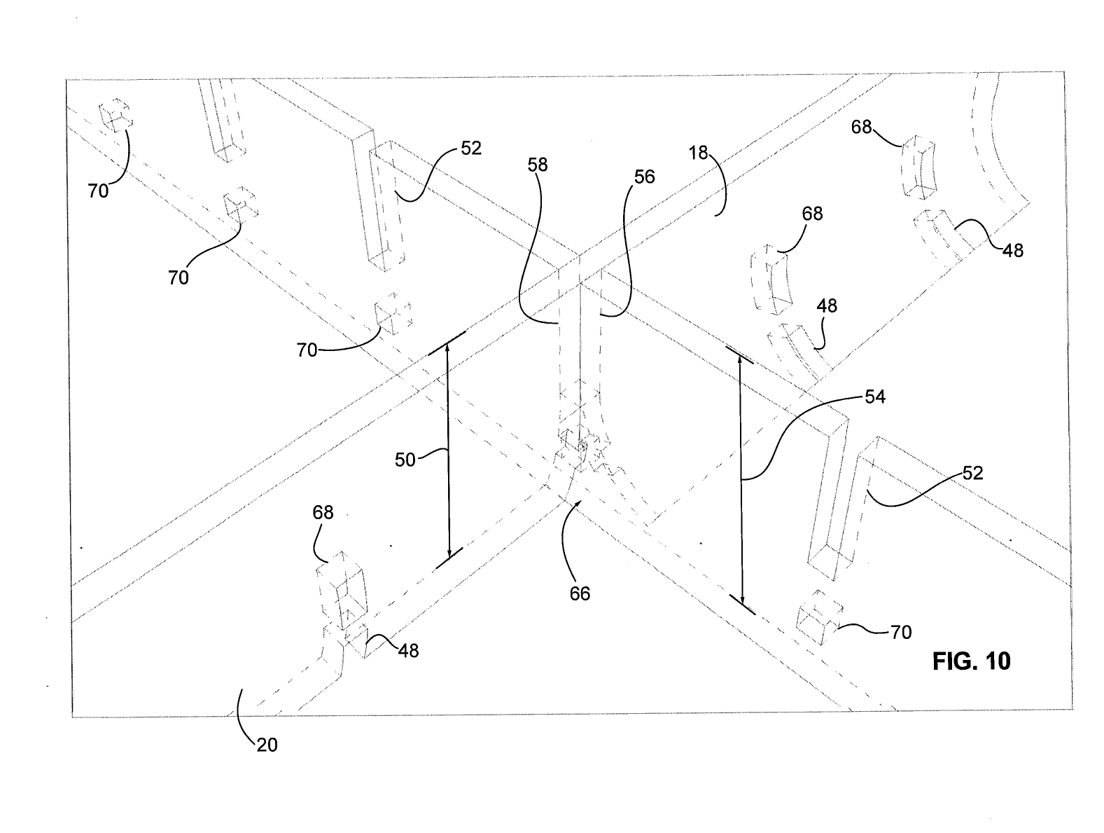

As previously mentioned, each second slat 20 is couplable with each first slat 18 for intersecting with each first slat 18. In the embodiment shown in FIGS. 9 and 10, the first slat 18 includes a plurality of longitudinally spaced apart first open-ended slots 48 each of which extends partially across a width 50 of the first slat 18. The second slat 20 includes a plurality of longitudinally spaced apart second open ended slots 52 each of which extends partially across a width 54 of the second slat 20. The first open-ended slots 48 are each co-operable with a corresponding one of the second open-ended slots 52. The plurality of first open-ended slots 48 corresponds in number to the number of second slats 20 and the plurality of second open-ended slots 52 corresponds in number to the number of first slats 18. During assembly, a first open-ended slot 48 is aligned with one of the second open-ended slots 52. As the first slat 18 and the second slat 20 are brought together for coupling, the first open-ended slot 48 receives a respective portion 58 of the second slat 20 and the second open-ended slot 52 receives a portion 56 of the first slat 18, as shown in FIG. 10.

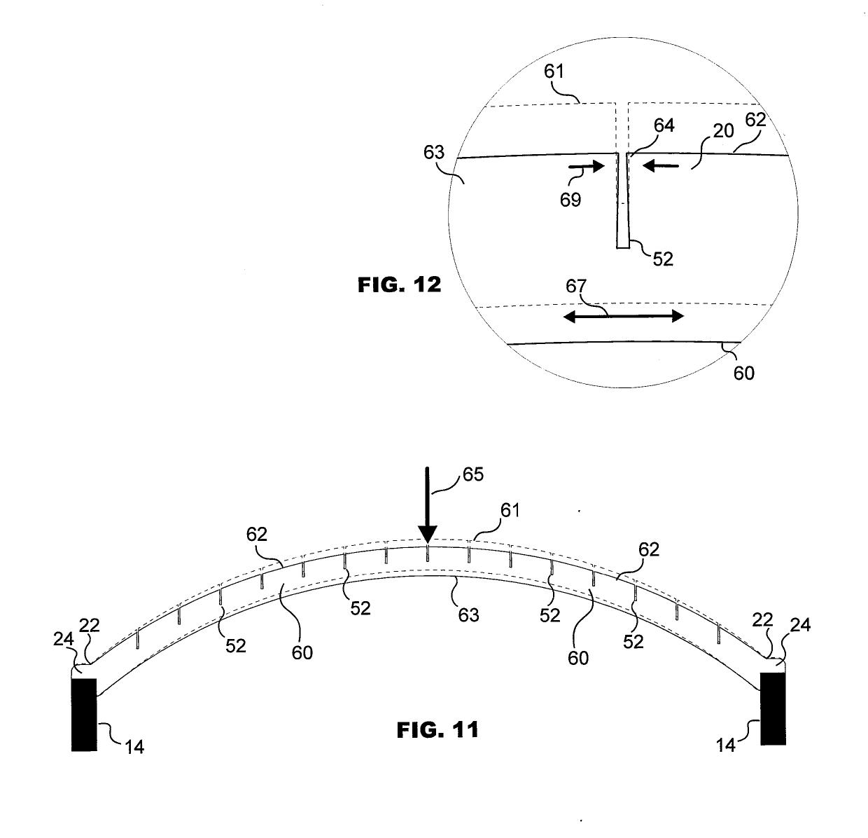

In one embodiment, when the acoustic assembly 10 is supported by the engagement portions 24 of first and second slats 18, 20 such as from a wall 14, for example, a pinching effect is created at the second open-ended slots 52 of second slats 20. The acoustic substrate from which the acoustic canopy 10 is constructed is preferably a semi-rigid material. It should be understood, however, that the pinching effect may also be created if a rigid material is used. Accordingly, acoustic canopy 10 may sag slightly, thereby creating a tension force along a bottom portion 60 of second slat 20 and a compression force along a top portion 62 of second slat 20 as shown in FIGS. 11 and 12. FIG. 11 shows an exemplary second slat 20 in a pre-sag position 61 shown in broken lines and a post-sag position 63 shown in solid lines as well as the gravitational forces acting on the exemplary second slat 20 shown by arrow 65. FIG. 12 shows the tension force and the compression force acting on the exemplary second slat 20 at one of the second open-ended slots 52 by way of arrows 67 and 69, respectively, where arrow 67 indicates tension forces and arrow 69 indicates compression forces. Since the open end 64 of the second open-ended slots 52 are spaced apart along the top portion 62 of the second slat 20, the compression force results in a narrowing of the open end 64 of second open-ended slot 52 as shown in FIG. 12. This narrowing pinches or sandwiches the portion of the first slat 18 that is received within the second open-ended slot 52. This pinching effect sandwiches each of the first slats 18 within the second open-ended slots 52 of second slats 20. The secure engagement between the first slats 18 and the second slats 20 provided by the first and second open-ended slots 48, 52 may be released by relieving the tension and compression forces on the first and second slats 18, 20.

There is also shown in FIGS. 9 and 10 a locking mechanism 66 for further securing the first slats 18 with the second slats 20. The first slat 18 includes a plurality of longitudinally spaced apart first apertures 68 each passing though the first slat 18. The second slat 20 includes a plurality of longitudinally spaced apart second apertures 70 each passing through the second slat 20. The plurality of first apertures 68 corresponds in number to the number of second slats 20 in the acoustic assembly 10 and the plurality of second apertures 70 corresponds in number to the number of first slats 18 in the acoustic assembly 10. The first slat 18 also includes a plurality of shear portions 72 coupled therewith and located adjacent to each first aperture 68. Each shear portion 72 has a slit 74 passing therethrough. The slit 74 extends between the first aperture 68 and the first open-ended slot 48. Since the material of the acoustic assembly 10 is preferably semi-rigid, the slit 74 is biased closed but allows for displacement of the shear portion 72 to permit selective opening and closing of the first apertures 68. The second slat 20 includes a plurality of catch portions 76 coupled therewith and located adjacent to each second aperture 70.

When the first aperture 68 is selectively open, a corresponding one of catch portions 76 is receivable within the first aperture 68. Once the catch portion 76 is received within the first aperture 68, the shear portion 72 may return to its closed position to secure the catch portion 76 within the first aperture 68. Conversely, the shear portion 72 is received within the corresponding second aperture 70 of the second slat 20. In this manner, the first slats 18 and the second slats 20 may be further coupled together securely in the acoustic assembly 10. Moreover, it should be understood that although the locking mechanism 66 secures the first slat 18 and the second slat 20 together, the locking mechanism 66 may be disengaged by simply opening the shear portion 72 and reversing the coupling process.

FIGS. 9 and 10 illustrate the intersection and locking mechanism 66 of one first slat 18 and one second slat 20. It should be understood that where a plurality of first slats 18 and/or a plurality of second slats 20 are used in the assembly, the above description relating to FIGS. 9 and 10 will apply equally to all points of intersection between first slats 18 and second slats 20. Moreover, although the shear portions 72 are shown as being coupled with the first slats 18 and the catch portions 76 are shown as being coupled with the second slats 20, it should be understood that the shear portions 72 could be coupled with the second slats 20 to be positioned adjacent the second apertures 70 and the catch portions 76 could be coupled with the first slats 18 to be positioned adjacent the first apertures 68.

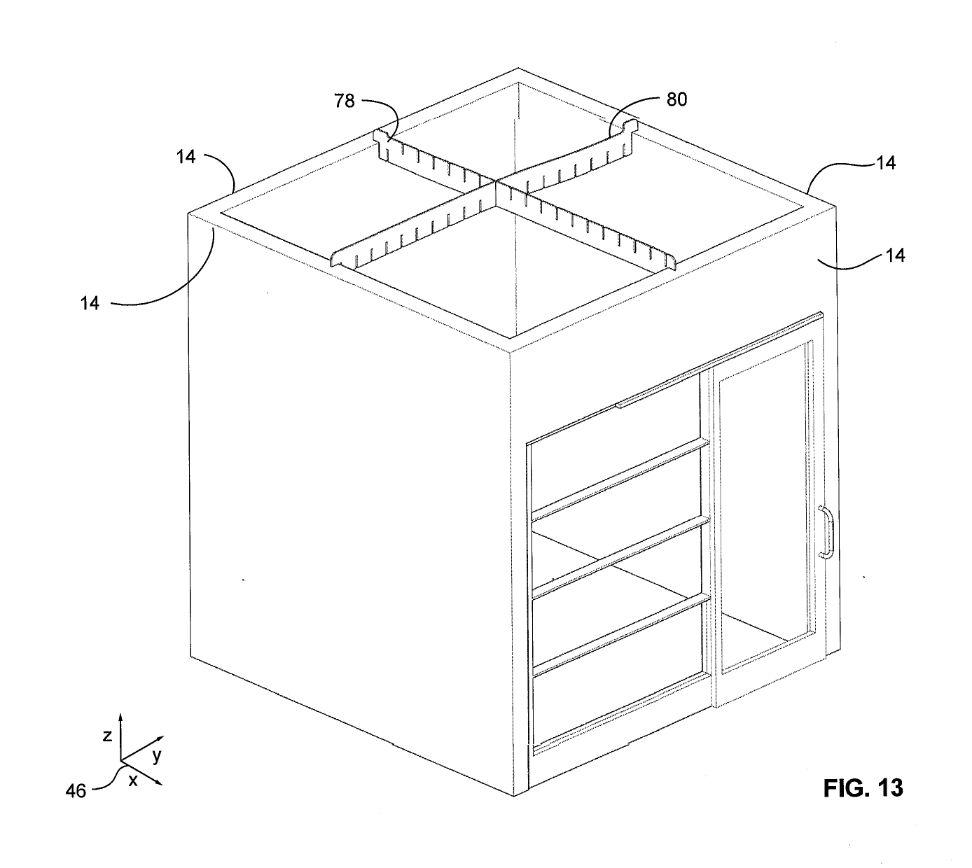

The acoustic assembly 10 shown in FIGS. 1 to 12 is preferably a self-supporting acoustic assembly 10. Support may, for example, be provided by the rigidity of the material used in the acoustic substrate of the acoustic assembly 10. However, as shown in FIG. 13, the acoustic assembly 10 may further include at least one support slat. The embodiment shown in FIG. 13 includes a first support slat 78 and a second support slat 80. First and second support slats 78, 80 are preferably fabricated from a rigid material and may not necessarily be an acoustic material. However, first and second support slats 78, 80 may be constructed from any rigid or semi-rigid material capable of lending further structural or load-bearing support to acoustic assembly 10 such as, for example, wood, plastic or aluminum. Acoustic assemblies which are large or which span large room may benefit from the additional structural or load-bearing support provided by first and second support slats 78, 80. Accordingly, support slats 78, 80 may, for example, function as cladding or backbone for the acoustic assembly 10.

One or more first support slats 78 may be included in the acoustic assembly 10 as a replacement for one or more of the first slats 18. Similarly, one or more of the second support slats 80 may be included in the acoustic assembly 10 as a replacement for one or more of the second slats 20. Each one of the first and second support slats 78, 80 preferably has the same profile as would a corresponding one of the first and second slats 18, 20.

While there have been described herein what are considered to be preferred and exemplary embodiments of the present invention, other modifications of these embodiments falling within the invention described herein shall be apparent to those skilled in the art.

What is claimed is:

1. An acoustic assembly comprising:
a plurality of first slats of acoustic material, each first slat having oppositely disposed first end portions;
at least one second slat of acoustic material couplable with each one of the plurality of first slats for intersecting with each of the first slats, each second slat having oppositely disposed second end portions; and,
an engagement portion coupled with each first end portion and each second end portion for resting atop at least one architectural element for supporting the acoustic assembly.

2. The acoustic assembly of claim 1, wherein:
the plurality of first slats are parallel relative one another.

3. The acoustic assembly of claim 1, wherein:
at least one of the plurality of first slats and the at least one second slat are fabricated from an acoustic substrate of one of a rigid material and a semi-rigid material.

4. The acoustic assembly of claim 1, further comprising:
a plurality of second slats.

5. The acoustic assembly of claim 4, wherein:
the plurality of second slats are parallel relative one another.

6. The acoustic assembly of claim 1, wherein:
the acoustic assembly is an acoustic canopy assembly; and,
the at least one second slat is couplable with each one of the plurality of first slats for intersecting with each of the first slats from beneath each of the first slats.

7. The acoustic assembly of claim 1, wherein:
the acoustic assembly at least one of absorbs, diffuses and directs sound.

8. The acoustic assembly of claim 1, wherein:
each engagement portion further comprises a supporting tab for extending onto the at least one architectural element for supporting the acoustic assembly.

9. The acoustic assembly of claim 1, wherein:
each of the first slats and each of the second slats each have a distinct profile defined by at least one of a respective arbitrary curve, an evolving radius, a linear form and a curvilinear form; and,
wherein the first slats and the second slats collectively provide the acoustic assembly with at least one undulation when the at least one second slat is intersected with the plurality of first slats.

10. The acoustic assembly of claim 9, wherein:
the at least one undulation includes at least one of a depression, a planar zone and a bulge.

11. The acoustic assembly of claim 1, wherein:
each of the first slats has a first profile defined by at least one of a first respective arbitrary curve, a first evolving radius, a first linear form and a first curvilinear form;
each of the second slats has a second profile defined by at least one of a second respective arbitrary curve, a second evolving radius, a second linear form and a second curvilinear form;
wherein the first slats collectively provide the acoustic assembly with a first undulation when the at least one second slat is intersected with the plurality of first slats, the first undulation visible from a first perspective; and,
wherein each of the second slats collectively provide the acoustic assembly with a second undulation when the at least one second slat is intersected with the plurality of first slats, the second undulation coincident with the first undulation and visible from a second perspective different from the first perspective.

12. The acoustic assembly of claim 1, further comprising:
at least one support slat for providing at least one of structural and load-bearing support to the acoustic assembly.

13. The acoustic assembly of claim 1, wherein:
the acoustic assembly is a free-standing structure.

14. An acoustic assembly comprising:
a plurality of first slats of an acoustic substrate of one of a rigid material and a semi-rigid material;
at least one second slat of the acoustic substrate couplable with each one of the plurality of first slats for intersecting with each of the first slats;
at least one first aperture passing through each first slat;
a plurality of second apertures passing through the at least one second slat and longitudinally spaced apart along the at least one second slat, the plurality of second apertures corresponding in number with the plurality of first slats;
a shear portion adjacent one of the at least one first aperture and each second aperture of the plurality of second apertures, the shear portion having a slit passing therethrough to the one of the at least one first aperture and each second aperture of the plurality of second apertures for selectively opening and closing the one of the at least one first aperture and each second aperture of the plurality of second apertures; and,
a catch portion adjacent an other one of the at least one first aperture and each second aperture of the plurality of second apertures; wherein,
when the one of the at least one first aperture and each second aperture of the plurality of second apertures is selectively open, the catch portion is receivable within the one of the at least one first aperture and each second aperture of the plurality of second apertures; and,
when the one of the at least one first aperture and each second aperture of the plurality of second apertures is selectively closed, the catch portion is removably securable within the one of the at least one first aperture and each second aperture of the plurality of second apertures and the shear portion is removably securable within the other one of the at least one first aperture and each second aperture of the plurality of second apertures.

15. The acoustic assembly of claim 14, wherein:
the plurality of first slats are parallel relative one another.

16. The acoustic assembly of claim 14, further comprising:
a plurality of second slats.

17. The acoustic assembly of claim 16, wherein:
the plurality of second slats are parallel relative one another.

18. The acoustic assembly of claim 14, wherein:
the acoustic assembly is an acoustic canopy assembly; and,
the at least one second slat is couplable with each one of the plurality of first slats for intersecting with each of the first slats from beneath each of the first slats.

19. The acoustic assembly of claim 14, wherein:
the acoustic assembly at least one of absorbs, diffuses and directs sound.

20. The acoustic assembly of claim 14, further comprising:
open-ended slots extending partially across each of the first slats and each of the second slats wherein each open-ended slot extends towards a respective one of the first apertures and second apertures wherein one of the shear portion and the catch portion is located between the open-ended slot and the respective one of the first apertures and second apertures.

21. The acoustic assembly of claim 14, wherein:
the shear portion is adjacent each first slat and the catch portion is adjacent each second slat.

22. The acoustic assembly of claim 14, wherein:
each of the first slats and each of the second slats has a distinct profile defined by at least one of a respective arbitrary curve, an evolving radius, a linear form and a curvilinear form; and,
wherein the first slats and the at least one second slat collectively provide the acoustic assembly with at least one undulation when the at least one second slat is intersected with the plurality of first slats.

23. The acoustic assembly of claim 14, wherein:
each of the first slats has a first profile defined by at least one of a first respective arbitrary curve, a first evolving radius, a first linear form and a first curvilinear form;
each of the second slats has a second profile defined by at least one of a second respective arbitrary curve, a second evolving radius, a second linear form and a second curvilinear form;
wherein the first slats collectively provide the acoustic assembly with a first undulation when the at least one second slat is intersected with the plurality of first slats, the first undulation visible from a first perspective; and,
wherein the second slats collectively provide the acoustic assembly with a second undulation when the at least one second slat is intersected with the plurality of first slats, the second undulation coincident with the first undulation and visible from a second perspective different from the first perspective.

24. The acoustic assembly of claim 22, wherein:
the at least one undulation includes at least one of a depression, a planar zone and a bulge.

25. The acoustic assembly of claim 14, wherein:
the slit bisects the shear portion.

26. The acoustic assembly of claim 14, further comprising:
at least one support slat for providing at least one of structural and load-bearing support to the acoustic assembly.

27. An acoustic canopy assembly comprising:
a plurality of first slats of an acoustic substrate of one of a rigid and a semi-rigid material, each first slat having opposed first end portions and a first open-ended slot extending partially across each first slat;
at least one second slat of the acoustic substrate, each second slat having opposed second end portions and a plurality of second open-ended slots extending partially across the at least one second slat, the plurality of second open-ended slots cooperable with corresponding ones of the first open-ended slots for receiving a corresponding one of the first slats within each second open-ended slot for intersecting each of the first slats from beneath the first slats; and,
wherein when the acoustic canopy is supported from the first and second end portions, the acoustic substrate of the at least one second slat sags to compress the second open-ended slots for pinching the corresponding ones of the first slats within the second slots.

28. The acoustic canopy assembly of claim 27, wherein:
the plurality of first slats are parallel relative one another.

29. The acoustic canopy assembly of claim 27, wherein:
each second slat includes a top portion extending longitudinally therealong and a bottom portion extending longitudinally therealong; and,
wherein when the at least one second slat sags, the top portion is under compression and the bottom portion is under tension.

30. The acoustic canopy assembly of claim 29, wherein:
when the top portion is under compression, the second open-ended slot is narrowed for pinching the corresponding one of the first slats within the second open-ended slot.

31. The acoustic canopy assembly of claim 27, further comprising:
a plurality of second slats.

32. The acoustic assembly of claim 31, wherein:
the plurality of second slats are parallel relative one another.

33. The acoustic canopy assembly of claim 27, wherein:
the acoustic assembly is an acoustic canopy assembly; and,
the at least one second slat is couplable with each one of the plurality of first slats for intersecting with each of the first slats from beneath each of the first slats.

34. The acoustic canopy assembly of claim 27, wherein:
the acoustic assembly at least one of absorbs, diffuses and directs sound.

35. The acoustic canopy assembly of claim 27, wherein:
each of the first slats and each of the second slats has a distinct profile defined by at least one of a respective arbitrary curve, an evolving radius, a linear form and a curvilinear form; and,
wherein the first slats and the second slats collectively provide the acoustic assembly with at least one undulation when the at least one second slat is intersected with the plurality of first slats.

36. The acoustic assembly of claim 27, wherein:
each of the first slats has a first profile defined by at least one of a first respective arbitrary curve, a first evolving radius, a first linear form and a first curvilinear form;
each of the second slats has a second profile defined by at least one of a second respective arbitrary curve, a second evolving radius, a second linear form and a second curvilinear form;
wherein the first slats collectively provide the acoustic assembly with a first undulation when the at least one second slat is intersected with the plurality of first slats, the first undulation visible from a first perspective; and,
wherein the second slats collectively provide the acoustic assembly with a second undulation when the at least one second slat is intersected with the plurality of first slats, the second undulation coincident with the first undulation and visible from a second perspective different from the first perspective.

37. The acoustic canopy assembly of claim 36, wherein:
the at least one undulation includes at least one of a depression, a planar zone and a bulge.

38. The acoustic assembly of claim 27, further comprising:
at least one support slat for providing at least one of structural and load-bearing support to the acoustic assembly.
